(19) United States
(12) Patent Application Publication
(10) Pub. No.: US 2014/0071492 A1
(43) Pub. Date: Mar. 13, 2014

(54) PRESENTATION OF ADDRESSES AT IMAGING DEVICES

(71) Applicants: Kevin J O'Neill, Boise, ID (US); Hector Rodriguez Aviles, Meridian, ID (US); Bradley R. Larson, Meridian, ID (US); Jerry A. Young, Nampa, ID (US); Jon Saunders, Folsom, CA (US)

(72) Inventors: Kevin J O'Neill, Boise, ID (US); Hector Rodriguez Aviles, Meridian, ID (US); Bradley R. Larson, Meridian, ID (US); Jerry A. Young, Nampa, ID (US); Jon Saunders, Folsom, CA (US)

(21) Appl. No.: 14/115,483

(22) PCT Filed: May 27, 2011
(86) PCT No.: PCT/US11/38385

§ 371 Date: Nov. 4, 2013

(51) Int. Cl. G06F 3/12

(52) U.S. Cl. CPC G06F 3/1293
USPC 358/1.15

(57) ABSTRACT

In one embodiment, an address to which a message can be sent to an imaging device is obtained. An image is generated, the image including the address in an encoded, machine-readable format. The image is provided for display to a mobile computing device capable of reading the image in the machine-readable format. A message is received from the mobile computing device via the address.

### BACKGROUND

An imaging device connected to a network is typically assigned a network address, internet protocol (“IP”) address, email address, or other address that identifies the device and/or distinguishes the imaging device from other devices on the network. A user with knowledge of the imaging device's address can utilize the address to send a message to the device from a smart phone, laptop computer, video game console, or other mobile computing device.

### BRIEF DESCRIPTION OF THE WINGS

The accompanying drawings illustrate various embodiments and are a part of the specification. The illustrated embodiments are examples and do not limit the scope of the claims. Throughout the drawings, identical reference numbers designate similar, but not necessarily identical elements.

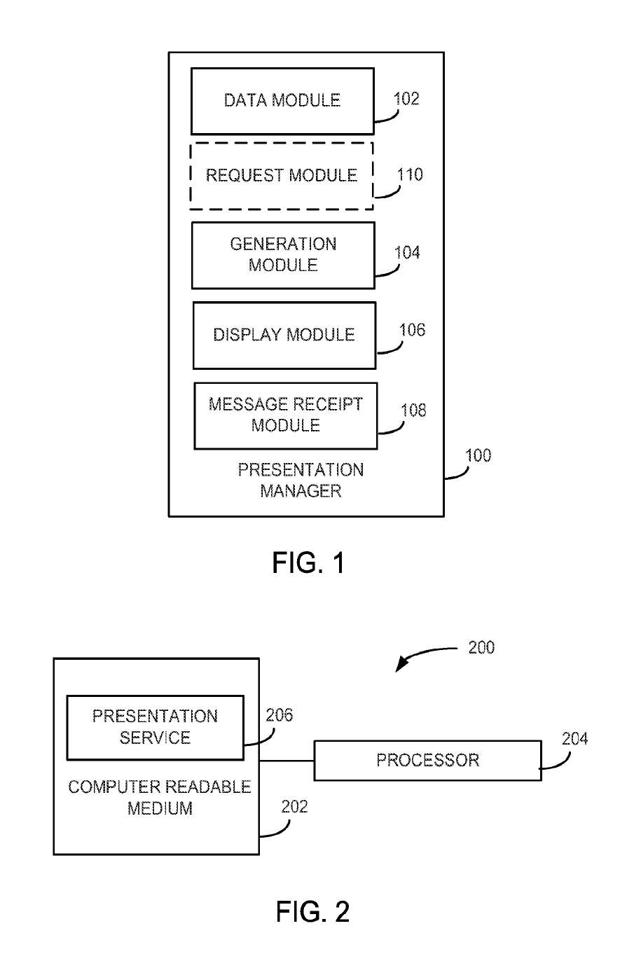

FIG. 1 depicts the logical components of a presentation manager according to an embodiment.

FIGS. 2-5 depict examples of various physical and logical components for implementing various embodiments.

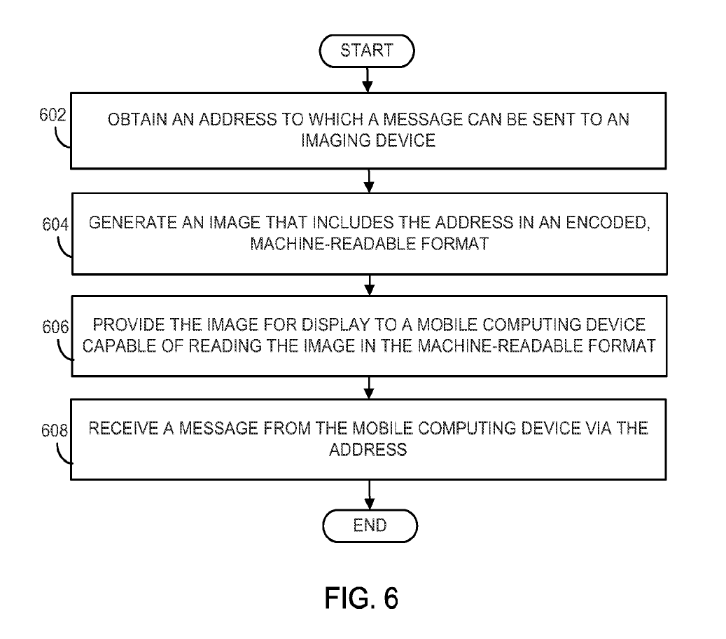

FIG. 6 is an example flow diagram depicting steps taken to implement various embodiments.

The same part numbers designate the same or similar parts throughout the figures.

### DETAILED DESCRIPTION OF EMBODIMENTS

Today many users of computing devices are highly mobile, and may need to establish quickly a connection with an unfamiliar imaging device in order to send a message (e.g., a print instruction, data to be printed, or a scan instruction) to the imaging device. In an example, a user of a smart phone mobile device may desire to send an instruction or other message to a printer imaging device located at an airport or hotel, expecting to utilize that printer no more than once. In order to print in this scenario, the user will commonly associate the smart phone with the printer by locating the address via a hard copy directory or via an interaction with a human, and then typing the located address via a keyboard, touchpad, or other user interface at the smart phone. However, finding a current, correct address can be a difficult task. Further, assuming that a current, correct address is found, it is easy for a user to mistype the printer's address into the smart phone. This typing difficulty is particularly true of email addresses for imaging devices, as in some cases the email addresses may be lengthy and contain a mix of alphabetical and numerical text. Typing or otherwise manually entering an incorrect imaging device address at the smart phone may result in customer delays, frustration and decreased usage.

Examples of a new method and system for presentation of addresses at imaging devices were developed in an effort to improve the time and accuracy of establishing a connection between a mobile computing device and an imaging device that is unfamiliar to the user. In one example of the new method and system, data representing the address is obtained. An image is generated that includes the address data in an encoded, machine-readable format. The image is provided for display at the imaging device to be accessible to a smart phone or other mobile computing device that can perceive the image and interpret the encoded machine-readable data image to discern the address. A message may then be received from the mobile computing device via the address. in embodiments, the encoded data within the image may include, in addition to the address data, other data such as printer diagnostic data and data relating to applications that may execute on the imaging device. Accordingly, users may be more likely to print at an unfamiliar imaging device, and user satisfaction will increase.

The embodiments shown in the accompanying drawings and described below are non-limiting examples. Other embodiments are possible and nothing in the accompanying drawings or in this Detailed Description of Embodiments should be construed to limit the scope of the disclosure, which is defined in the Claims.

As used in this specification, an “imaging device” means generally any computing device capable of capturing, copying, printing, or making an image. The term “imaging device” includes, but is not limited to a printer, a scanner, a digital sending device, and any device that combines printing, scanning, or digital sending functionality with other functionality. An “address” for an imaging device means an identifier for the imaging device relative to other computing devices on a network, and may include, but is not limited to, an IP Address or an email address. The term “mobile computing device” includes any portable computing device capable of communicating with another computing device. A “message” means any electronic communication, including, but not limited to an instruction or request, and may include data. “Printer” means any electronic device that prints and includes multifunctional electronic devices that perform additional functions such as scanning and/or copying. “Image” means a visual representation of an object, scene, person, or abstraction (including text and geometric shapes). “Encoded” means presented in a format that is generally not readable by a human without the aid of a machine. “Digital watermark” means an image with an embedded digital signal. “Security token” means generally data or programming to authenticate, identify, or validate, including authentication, identification or validation of a computing device, machine, individual, transaction, service, process or thing.

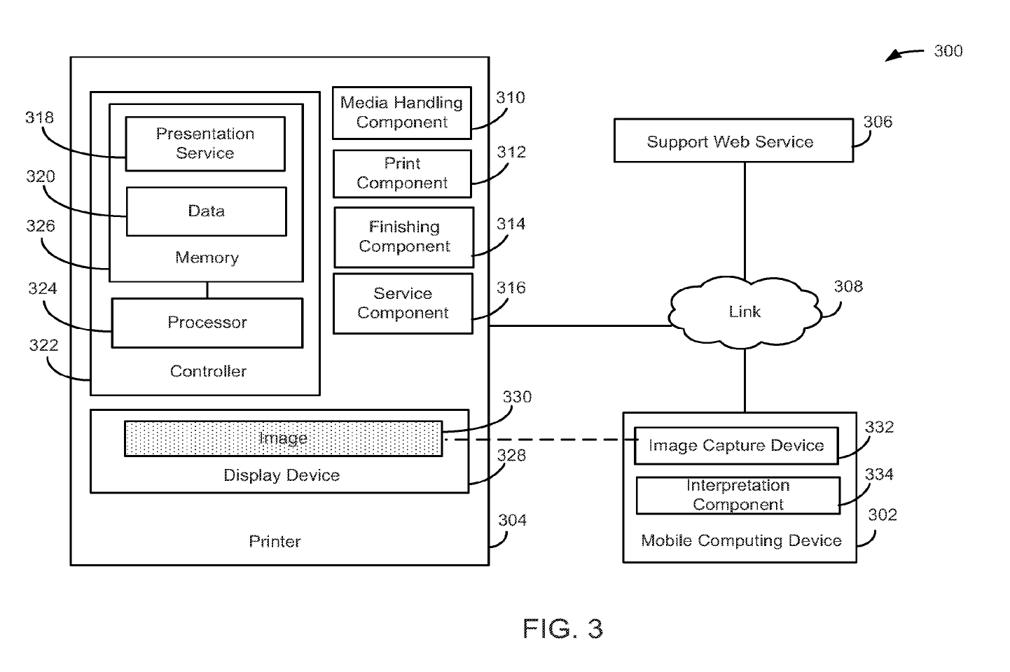

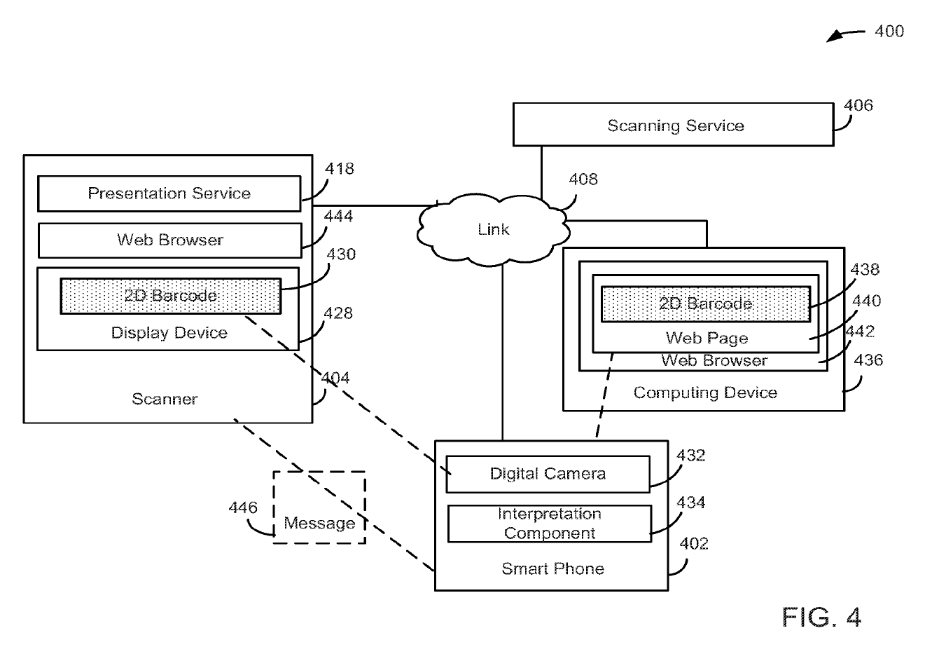

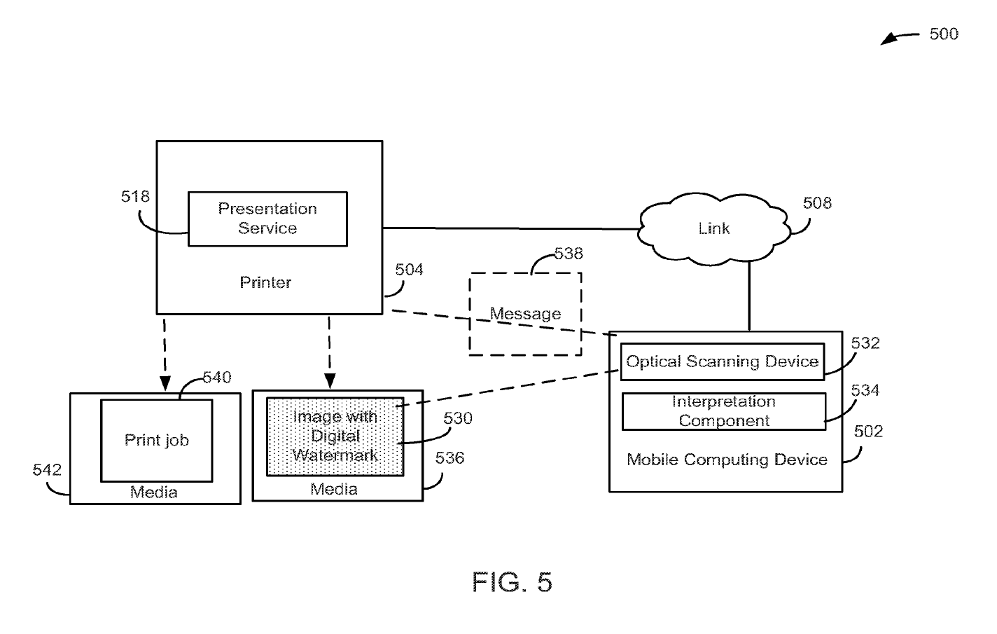

COMPONENTS: FIG. 1 is an example block diagram illustrating the logical components of a presentation manager 100. Presentation manager 100 represents generally any combination of hardware and programming configured to implement presentation of an address at an imaging device. Presentation manager 100 may be implemented in a number of environments, such as environment 200 of FIG. 2, environment 300 of FIG. 3, environment 400 of FIG. 4, and environment 500 of FIG. 5. In the example of FIG. 1, presentation manager 100 includes a data module 102, generation module 104, display module 106, message receipt module 108, and request module 110.

Data module 102 represents generally any combination of hardware and programming configured to obtain data that includes an address to an imaging device or an address to which messages can be sent to an imaging device. Data may include, but is not limited to, numbers, text, images, or sounds. In an embodiment, data that includes the address is obtained from the imaging device. In another embodiment, address data is obtained from a source external to the imaging device via a networking protocol, including but not limited to Transmission Control Protocol/Internet Protocol (“TCP/IP”), HyperText Transfer Protocol (“HTTP”), Simple Mail Transfer Protocol (“SMTP”), Extensible Messaging and Presence Protocol (“XMPP”) and/or Session Initiation Protocol (“SIP”). In an embodiment, the data is obtained via an application that is executed at the imaging device. In an embodiment, the data is obtained via an application that is executed at a computing device, e.g., a print management server, distinct from the imaging device.

In an embodiment, the obtained data may include data in addition to the address. For example, the obtained data may include diagnostic data regarding the imaging device. The data can be a history of events occurring at the imaging device, which history can be valuable in troubleshooting a problem or error at the imaging device. In another example, the data includes supply or service ordering data that is relevant to the imaging device. in other examples, the data may include, in addition to the address, a coupon, a security token, data relating to an application that is executed on the imaging device, or a website address. A security token may include, but is not limited, to a software token, software key, password, digital signature, or biometric data.

Generation module 104 represents generally any combination of hardware and programming configured to generate an image that includes the obtained data in an encoded, machine-readable format. In embodiments, the image may be stored in a various languages and formats including but not limited to JPEG, DOC, DOCX, PDF, TIFF, XLS, PPT, PPTX, Open Office, or imaging device language formats such as HPGL12, PostScript, or PCL3.

The generated image includes the data in an encoded, machine-readable format. In embodiments, the generated image is a barcode. A typical use of a barcode is to provide data about an object to which the barcode is affixed, or about a picture or text to which the barcode is adjacent. Examples of barcodes include, but are not limited to, linear barcodes (1D barcodes), rectangles, dots, hexagons and other geometric patterns in 2 dimensions (2D barcodes), and barcodes in which a third dimension (such as a color variation or a tactile variation) is considered in addition to the geometric patterns present in a 2D barcode (3D barcodes). Examples of 1D barcodes are EAN and UCC barcodes, Examples of 2D barcodes are QR codes, GS1 Databars, PDF 417s, data matrixes, maxicodes, Microsoft® tags and Aztec codes.

In other embodiments, the generated image is ire a digital watermark format. In “visible” digital watermarking, the encoded data may be included as signal in the digital image in a manner that is visible to, but not readable by, a human observer. An example of use of a visible digital watermark is an image that includes a 2D barcode visibly embedded as a signal in the image. In “invisible” digital watermarking, the encoded data is included as signal within the digital image and it is generally not visible to a human observer.

In other embodiments, the image may contain encoded data in the form of metadata in a computer programming language. In an example, metadata in XML, C++, or another computer language can be displayed in a manner such that meaning of the metadata is generally not readable by a human observer with the naked eye. In another example, the metadata is to be displayed at a font size that is not detectable or not readable by a human observer. In another example, the metadata is configured to be displayed between portions or frames of the image in a manner such that the metadata is generally not detectable or not readable by a human observer.

Display module 106 represents generally any combination of hardware and programming configured to provide the image for display to a mobile computing device capable of reading the image in the machine.-readable format. In an embodiment, providing the image for display occurs via an electronic display device included within the imaging device, such that the image is available for perception of the image, and interpretation of the encoded data, at a mobile computing device. The display device may be imaging device's control panel, and may be in the form of a liquid crystal display (LCD) monitor, a touchscreen device, a projection device, or any other type of electronic display device. A mobile computing device can perceive the image by attaining, acquiring, or capturing a copy of the image (e.g., utilizing a camera), by analyzing the image (e.g., by scanning the image with an optical scanner), or by other means.

In an embodiment in which the imaging device is a printer, providing the image for display occurs via printing the image (that includes the data in an encoded, machine-readable format) upon a paper or other print media (“media”) at the printer. The image is available for perception and interpretation by a mobile computing device with image recognition and image interpretation capabilities. In an embodiment, the media upon which the image is printed is presented at a display window, affixed to the printer, or otherwise presented at the printer in a manner other than via an output tray. In an embodiment, the movement of the media to a display window at the printer, or to be affixed to the printer is automatic via a media transport and display system included within the printer.

In an embodiment, in addition to providing the image for display at the imaging device, the image is also caused to be displayed at a web page accessible at a computing device separate from the imaging device via a web browser included within such computing device. In an example, the image may be displayed at a configuration web page for a web-enabled imaging device. The configuration page allows a user to set up the imaging device, change settings for the imaging device and/or send an instruction, print request, scan request, data to be printed, (sometimes referred to herein as a “print job”) or other message to the imaging device via accessing the web page. A smart phone or other mobile computing device may perceive the image and interpret the encoded, machine-readable data included within the image. The interpreted day may be utilized to send a message, and/or stored on the smart phone's contact database for quick retrieval to send a message later. in another embodiment, the data included within the image contains diagnostic data regarding the imaging device and the data can be forwarded by the smart phone to a help desk or diagnostics service to aid in troubleshooting an imaging device error.

Message receipt module 108 represents generally any combination of hardware and programming configured to receive a message from a mobile computing device via the address. in an example, the message may be received via a Bluetooth™, a Wi-Fi™, a near field communication (“NFC”), or other communication protocol. In an embodiment, the message includes data to be printed by the imaging device. In an embodiment, the message includes a URL, web address, or other address for data to be printed. In an embodiment, the message includes a request that the imaging device send scanned data to the mobile device.

In an embodiment, presentation manager 100 additionally includes a request module 110. Request module 110 represents generally any combination of hardware and programming configured to receive a request to generate an image that includes data in encoded, machine-readable format. In an example, the request may be received from a smart phone, tablet computer, laptop computer, video game console, or other mobile computing device that has a capability to perceive the image and interpret the encoded, machine-readable data. The request may be received via a Bluetooth™, a Wi-Fi™, a near field communication (“NFC”), or other communication protocol.

Presentation manager 100 may be implemented in a number of environments, such as environment 200 of FIG. 2. Environment 200 includes a computer-readable medium 202, and a processor 204. In a given implementation, computer-readable medium 202 may represent multiple computer-readable media and processor 204 may represent multiple processors.

Computer-readable medium 202 represents generally any medium that can contain, store, or maintain programs and data for use by or in connection with an instruction execution system. Computer-readable medium can include any one of many physical media such as, for example. electronic, magnetic, optical, electromagnetic, or semiconductor media. More specific examples of suitable computer-readable media include, but are not limited to, hard drives, random access memory (RAM), read-only memory (ROM), erasable programmable read-only memory, flash drives, compact discs, and digital video discs. In an embodiment, a number of software components are stored in the computer-readable medium 202 and are executable by processor 204. In this respect, the term “executable” includes a program file that is in a form that can be directly (e.g., machine code) or indirectly (e.g., source code that is to be compiled) performed by the processor 204. An executable program may be stored in any portion or component of computer-readable medium 202.

Processor 204 represents generally any instruction execution system, such as a computer/processor based system or an ASIC (Application Specific Integrated Circuit), a computer, or other system that can fetch or obtain instructions or logic from computer-readable medium 202 and execute the instructions or logic contained therein.

Computer-readable medium 202 is shown to include presentation service 206. Presentation service 206 represents generally any programming, that when executed, implements the functionality of the presentation manager 100 of FIG. 1. In an embodiment, presentation service 206, when executed by processor 204, is responsible for obtaining data that includes an IP address, email address, or other address to which messages can be sent to an imaging device. The obtained data may include data in addition to the address. An image is generated that includes the data in an encoded, machine-readable format. In an embodiment, the image is generated in response to the presentation service receiving a request to generate the image from a mobile computing device distinct from the imaging device. In embodiments, the image may be generated in barcode, digital watermark, or metadata formats.

The image that is provided for display is available for optical scanning (e.g., via a scanning unit), image capture (e.g., via a digital camera), or other perception of the image. After the scanning, capture, or other perception of the image by the mobile computing device, the encoded machine-readable data is interpreted by the mobile computing device. The data may be utilized by the mobile computing device to send an instruction, request, print job, or other message that is received at the imaging device, and/or stored at the mobile computing device.

Presentation manager 100 may also be implemented in an environment such as environment 300 of FIG. 3. Environment 300 is shown to include a mobile computing device 302, a printer 304, and a support web service 306 interconnected via link 308.

Mobile computing device 302 represents generally any combination of hardware and software capable of perceiving an image displayed at printer 304, interpreting encoded, machine-readable data included within the image, and sending, or causing the sending from another device, of a message, including data to be printed, to printer 304. In embodiments, mobile computing device 302 may be a smart phone, tablet computer, or laptop computer. Mobile computing device 302 includes an image capture device 332, which in embodiments may be an optical scanner, a digital camera, or other image capture device. Mobile computing device 302 additionally includes an interpretation component 334 to interpret encoded, machine-readable data.

Printer 304 represents generally any computing device operable to receive and process responses to requests to print content and to produce printed output. Printer 304 is capable of receiving a message, which may include data to be printed, from mobile computing device 302 and other computing devices. Printer 304 is additionally capable of implementing the functionality of the presentation manager 100 of FIG. 1. Printer 304 is shown to include media handling component 310, print component 312, finishing component 314, service component 316, presentation service 318, data 320, and controller 322.

Media handling component 310 represents generally any combination of hardware and programming capable of transporting media through the printer 304. The media may be supplied for printing via a media roll, the media roll positioned within, or adjacent, to a housing of printer 304 during printing operations. Print component 312 represents generally any combination of elements capable of being utilized to form desired images on media. In a given example, print component 312 may include a fluid ejection mechanism, each fluid ejection mechanism including multiple printheads configured to dispense ink or other fluid. As used in this specification, “printhead” includes a mechanism having a plurality of nozzles through which ink or other fluid is ejected. Examples of printheads are drop-on-demand inkjet printheads, thermo resistive printheads, piezo and resistive printheads. Some printheads may be part of a cartridge which also stores the fluid to be dispensed. Other printheads are standalone and are supplied with fluid by an off-axis ink supply. In other examples, print component 312 may include combinations of elements capable of being utilized for printing by laser, piezoelectric, or other methods of printing. Finishing component 314 represents generally any combination of hardware and pro ramming capable of performing a finishing operation on media. Such finishing operations include cutting, folding, laminating or any other action that affects the physical nature of the media. Service component 316 represents generally any combination of elements capable of being utilized to service print component 312. In an example, service component 316 may be configured to function as a spittoon and an alignment calibrator to service printheads.

Presentation service 318 represents generally any programming, that, when executed, implements the functionality of the presentation manager 100 of FIG. 1. In particular, presentation service 318, when executed by processor 324, is responsible for obtaining data 320 that includes an IP address, email address, or other address to which a message can be sent to printer 304. In embodiments, the data 320 is fetched or retrieved from a memory 326 located within the printer 304. In another embodiment, the obtained data is fetched or retrieved from a database, external to printer 304, available via a network. In an embodiment, the obtained data is received via an application that is executed at a computing device, e.g., a print management server, distinct from the printer 304,

An image 330 is generated at the printer 304 that includes the data 320 in an encoded, machine-readable format. In an embodiment, the image 330 is generated in a barcode format. In other embodiments, the image 330 that includes the encoded, machine-readable data is generated in a visible or invisible digital watermark format. In an embodiment, the image 330 may contain encoded data in the form of metadata in a computer programming language displayed in a manner such that substance of the message is not detectable or interpretable by a human observer.

The image 330 that includes the encoded, machine-readable data is provided for display, to a mobile computing device 302 capable of reading the image 330 in the machine-readable format, at the printer 304. In an embodiment, providing for display occurs via an electronic display device 328 included within the printer. After capture of the image 330 by an image capture device 332 included within mobile computing device 302, the encoded data is interpreted at interpretation component 334. In an embodiment, interpretation component 334 communicates with an interpretation web service available via an interne connection to accomplish interpretation of the data. The address data included within the image may be stored in a memory at the mobile computing device 302 for use in addressing a print instruction including a print job or another message to be sent to the printer 304.

Data 320 represents generally a collection or database of obtained data including an IP address, email address, or other address for the printer 304. Data 320 may include additional data relating to the printer, such as diagnostic data regarding the printer, capabilities data relating to printer, media capabilities, and web application capabilities. Data 320 may include information regarding printer supplies and services offerings for the printer, including ordering information for such supplies and services. Data 320 may include coupons, security tokens and/or other data relating to applications that may execute at the printer 304, or at support web service 306, or at any other web service that is frosted at a server distinct from printer 304 and is accessible to printer 304 via link 308.

Controller 322 represents generally any combination of elements capable of coordinating the operation of components 310, 312, 314, 316, and 318. In a given implementation, controller 322 includes a processor 324 and a memory 326. The processor 324 may represent multiple processors, and the memory 326 may represent multiple memories. In an embodiment, the controller 322 may include a number of software components that are stored in a computer-readable medium, such as memory 326, and are executable by processor 324. An executable program may be stored in any portion or component of memory 326.

Support web service 306 represents generally any combination of hardware and programming configured to communicate with mobile computing device 302 and/or printer 304. In an embodiment, support web service 306 comprises a server or a server system, or other computing device or system of computing devices, accessible to the mobile computing device 302 via the internee or another network. in an example, support web service 306 may be a printer part or supplies ordering service, or printer help desk service. Support web service 306 is accessible to mobile computing device 302 by virtue of data 320 (e.g., a website address, co non, and/or security token). The data 320 is made available to mobile computing device 302 via the perception and interpretation of encoded, machine-readable data included within image 330 presented at printer 304.

Mobile computing device 302, printer 304 and support web service 306 are interconnected via link 308. Link 308 represents generally one or more of a cable, wireless, fiber optic, or remote connection via telecommunication link, an infrared link, a radio frequency link, or any other connectors or systems that provide electronic communication. Link 308 may include, at least in part, an intranet, the Internet, or a combination of both. Link 308 may also include intermediate proxies, routers, switches, load balancers, and the like. The paths followed by link 308 between mobile computing device 302, printer 304 and support web service 306 as depicted in FIG. 3 represent the logical communication paths between these devices, not necessarily the physical paths between the devices.

Presentation manager 100 may also be implemented in an environment such as environment 400 of FIG. 4. Environment 400 includes smart phone 402, scanner 404, scanning service 406, and computing device 436 interconnected via link 408.

Smart phone 402 represents generally any mobile communication and computing device capable of perceiving a 2D barcode image 430 displayed at scanner 404, and interpreting encoded, machine-readable data included within the image 430. Smart phone 402 includes a digital camera 432 to capture the 2D barcode image 430 and an interpretation component 434 to interpret the data.

Scanner 404 represents generally any computing device operable to receive and process responses to requests to scan content and to produce a digital copy of such content. Scanner 404 is a web-enabled scanner capable of receiving a scanning instruction or other message from smart phone 402, of communicating with scanning service 406, and of implementing the functionality of the presentation manager 100 of FIG. 1. Scanner 404 is capable of receiving a scanning instruction or other message directly from smart phone 402 or indirectly from smart phone 402 via scanning service 406. Scanner 404 is shown to include a presentation service 418, a web browser 444, and electronic display device 428. Web browser 444 represents generally any combination of hardware and programming configured to retrieve, present, and traverse information over the Internet or an intranet.

Presentation service represents generally any programming, that, when executed, implements the functionality of the presentation manager 100 of FIG. 1. In particular, presentation service 418, when executed by a processor, is responsible for obtaining data that includes an address to which messages can be sent to a scanner, The obtained data may include an IP address, email address, or other address for the scanner. In an embodiment, the obtained data may include data in addition to the address. An image is generated that includes the data in an encoded, machine-readable 2D barcode 430 format that is generally not interpretable by a human observer. The 2D barcode 430 is displayed at the scanner 404 via the electronic display device 428 included within the scanner 404.

After capture of the 2D barcode 430 by a digital camera 432 included within smart phone 402, the encoded, machine-readable data interpreted by the interpretation component 434. The address data included within the 2D barcode 430 (e.g., an IP address or an email address) may be utilized by the smart phone 404 to immediately send a scan instruction or other message to the scanner 404, or and/or the address data may be stored in a memory at the smart phone 402 for future use. In this example, the scanner 404 receives a message 446 from the smart phone 402, the message 446 including a request that the scanner 404 send scanned data to the smart phone 402.

In the embodiment shown in FIG. 4, in addition to displaying the 2D barcode at the scanner 404, the 2D barcode is also caused to be displayed 438 at a web page 440 accessible via a web browser 442 at computing device 436. In an embodiment, the web page 440 is a configuration web page for web-enabled scanner 404, which configuration page allows a user to set up the scanner 404, change settings for the scanner 404 and/or send scan instructions or other messages to the scanner 404 via the web page 440. In the example of FIG. 4, the web page 440 is hosted by a scanning service 406. The smart phone 402 perceives and interprets the 2D barcode displayed 438 via the web browser 442. Diagnostic data regarding scanner 404 included within the 2D barcode may be forwarded by the smart phone 402 to a help desk or diagnostic support service 306 (FIG. 3) to aid in troubleshooting an error at scanner 404.

Scanning service 406 represents generally any combination of hardware and programming configured to communicate with mobile computing device 402 and scanner 404. In an embodiment, scanning service 406 comprises a server or a server system, or other computing device or system of computing devices, accessible to the smart phone 402 via the internet or another network. In an example, scanning service 406 may host a configuration web page for scanner 404 that allows a user to set up the imaging device, change settings for the scanner 404 and/or send a scan instruction, scan request, data or other message to the imaging device via accessing the web page.

Link 408 represents generally one or more of a cable, wireless, fiber optic, or remote connection via a telecommunication link, an infrared link, a radio frequency link, or any other connectors or systems that provide electronic communication. Link 408 may include, at least in part, an intranet, the Internet, or a combination of both.

Presentation manager 100 may also be implemented in an environment such as environment 500 of FIG. 5. Environment 500 includes mobile computing device 502 and printer 504 interconnected via link 508,

Mobile computing device 502 represents generally any combination of hardware and software capable of sending, or causing the sending, of a message to printer 504, perceiving an image 530 displayed at printer 504, and interpreting a digital watermark included within the image 530. Mobile computing device 502 includes an optical scanner 532 to capture the image and an interpretation component 534 to interpret the data.

Printer 504 represents generally any computing device operable to receive and process responses to requests to print content and to produce printed output. In embodiments printer 504 may be an inkjet, laser, piezoelectric, or any other type of imaging device. Printer 504 is capable of receiving messages, including but not limited to print jobs, from mobile computing device 502 and of implementing the functionality of the presentation manager 100 of FIG. 1.

Printer 504 is shown to include a presentation service 518. Presentation service 518 represents generally any programming, that, when executed, implements the functionality of the presentation manager 100 of FIG. 1. In particular, presentation service 518, when executed by a processor, is responsible for obtaining data that includes an IP address, email address or other address to which messages can be sent to printer 504. In an embodiment, the obtained data may include data in addition to the address, e.g., information relevant to error troubleshooting or ordering supplies or services for printer 504. An image is generated that includes the data in an encoded, machine-readable digital watermark 530 format.

The generated image 530 with the digital watermark is provided for display to mobile computing device 502 via printing the image 530 upon a paper or other print media 536 at the printer 504. The image 530 is available for perception of the image by optical scanner 532, and interpretation of the encoded, machine-readable data at interpretation component 534. After scanning of the digital watermark and interpretation at mobile computing device 502, the address data can be utilized to send a message 538 to printer 504 that includes a print job to be printed by the printer 504. Printer 504 receives the message 538 and in response to the message 538 prints the print job 540 upon a media 542.

Link 508 represents generally one or more of a cable, wireless, fiber optic, or remote connection via a telecommunication link, an infrared link, a radio frequency link, or any other connectors or systems that provide electronic communication. Link 508 may include, at least in part, an intranet, the internet, or a combination of both.

In the foregoing discussion, various components were described as combinations of hardware and programming. Such components may be implemented in a number of fashions. In one example, the programming may be processor executable instructions stored on tangible memory media and the hardware may include a processor for executing those instructions. Thus, certain elements operating on the same device may share a common processor and common memory media. Components operating on different devices, then, may utilize different processors and memory media.

OPERATION: FIG. 6 is an example of steps taken to implement various embodiments. In discussing FIG. 6, reference may be made to the diagrams of FIGS. 1-5 to provide contextual examples. Implementation, however, is not limited to those examples. FIG. 6 depicts a workflow from the perspective of a presentation service such as presentation service 206 of FIG. 2, presentation service 318 of FIG. 3, presentation service 418 of FIG. 4, or presentation service 518 of FIG. 5.

Starting with FIG. 6, an address to which a message can be sent to an imaging device is obtained (block 602). Referring back to FIG. 1, the data module 102 may be responsible for implementing block 602.

Continuing with the flow diagram of FIG. 6, an image is generated, the image including the address in an encoded, machine-readable format (block 604), Referring back to FIG. 1, the generation module 104 may be responsible for implementing block 604.

Continuing with the flow diagram of FIG. 6, the image is provided for display to a mobile computing device capable of reading the image in the machine-readable format (block 606). Referring back to FIG. 1, the display module 106 may be responsible for implementing block 606.

Continuing with the flow diagram of FIG. 6, a message is received from the mobile computing device via the address (block 608). Referring back to FIG. 1, the display module 108 may be responsible for implementing block 608.

CONCLUSION: The diagrams of FIGS. 1-5 are used to depict the architecture, functionality, and operation of various embodiments. Various components illustrated in FIGS. 1-5 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present disclosure may be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein.

Although the flow diagram of FIG. 6 shows specific orders of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

The preceding description has been presented only to illustrate and describe embodiments and examples of the principles described, This description is not intended to be exhaustive or to limit these principles to any precise form disclosed. Many modifications and variations are possible in light of the above teaching.

What is claimed is:

1. A method to present an address at an imaging device, comprising the steps of:
providing the an image for display to a mobile computing device, capable of reading the image in the machine-readable format
the image comprising an address, in an encoded, machine-readable format, to which a message can be sent to the imaging device, and
the mobile computing device capable of reading the image in the machine-readable format:
receiving a message from the mobile computing device via the address.

2. The method of claim 1, wherein the message includes data to be printed by the imaging device.

3. (canceled)

4. The method of claim wherein the address comprises an internet protocol address or an email address.

5. (canceled)

6. The method of claim 1, wherein the image comprises a barcode.

7. The method of claim 1, wherein the image comprises a digital watermark.

8. The method of claim 1, wherein the imaging device is a printer.

9. The method of claim 1, wherein providing an image for display comprises providing the image via an electronic display device comprised within the imaging device.

10. The method of claim 1, further comprising the a-of-displaying the image at a web page,

11. The method of claim 1, wherein providing an image for display comprises printing the image upon a media.

12. The method of claim 1, wherein the image comprises the diagnostic data.

13. The method of claim 1, wherein the the image further comprises supply or service ordering data.

14. The method of claim 1, wherein the image comprises at least one of data including a coupon, data including a security token, and data relating to an application that is executed on the imaging device.

15. A system to present an address at an imaging device, comprising:
a display module, configured to provide an image in a machine-readable format for display to a mobile computing device capable of reading the image in the machine-readable format, wherein the image comprises an address to which a message can be sent to the imaging device; and
a message receipt module, configured to receive a message from a mobile computing device via the address.

16. (canceled)

17. The system of claim 15, wherein the message includes a request that the imaging device send scanned data to the mobile computing device.

18. (canceled)

19. (canceled)

20. (canceled)

21. The system of claim 15, further comprising a request module, configured to receive a request to generate the image from a mobile computing device.

22. (canceled)

23. A printer, comprising:
a processor:
a print component;
an electronic display device;
a data module, configured to obtain an email address to which a message can be sent to the printer;
a generation module, configured to generate a barcode image that comprises the address in an encoded, machine-readable format:
a display module, configured to provide the image for display to a mobile computing device capable of reading the image in the machine-readable format;
a message receipt module, configured to receive a message from the mobile computing device via the address.

24. The method of claim 1, further comprising generating the image.

25. The method of claim 2, further comprising obtaining the address.

26. The method of claim 2, further comprising obtaining supply or service ordering data, and wherein the image further comprises the supply or service ordering data.

27. The system of claim 1 further comprising:
a data module, configured to obtain the address and
a generation module, configured to generate the image.
